(19) United States
(12) Patent Application Publication
(10) Pub. No.: US 2018/0062166 A1
(43) Pub. Date: Mar. 1, 2018

(54) ELECTRODE MATERIAL AND BATTERY

(71) Applicant: Panasonic Intellectual Property Management Co., Ltd., Osaka (JP)

(72) Inventor: IZURU SASAKI, Kyoto (JP)

(21) Appl. No.: 15/661,164

(22) Filed: Jul. 27, 2017

(30) Foreign Application Priority Data
Aug. 23, 2016 (JP) 2016-162352

(51) Int. Cl. H01M 4/36; H01M 4/525; H01M 10/0525; H01M 10/0562

(52) U.S. Cl. CPC H01M 4/366; H01M 4/525; H01M 2300/0094; H01M 10/0562; H01M 2300/0071; H01M 10/0525

(57) ABSTRACT

An electrode material according to one aspect of the present disclosure includes a sulfide solid electrolyte material, an electrode active material, and a cover layer containing a cover material, the sulfide solid electrolyte material has a sulfide layer containing a sulfide material and an oxide layer which contains an oxide formed by oxidation of the sulfide material and which is located on a surface of the sulfide layer. The cover layer is provided on a surface of the electrode active material.

### BACKGROUND

### 1. Technical Field

The present disclosure relates to an electrode material for a battery and a battery.

### 2. Description of the Related Art

International Publication No. 2007/004590 has disclosed an all-solid lithium battery in which the surface of an active material is covered with a lithium ion conductive oxide.

Japanese Unexamined Patent Application Publication No. 2012-94445 has disclosed a sulfide solid electrolyte grain having an oxide layer formed by oxidation thereof as a surface layer of the grain.

### SUMMARY

In related techniques, a further improvement in charge-discharge efficiency of a battery has been desired.

In one general aspect, the techniques disclosed here feature an electrode material which comprises a sulfide solid electrolyte material, an electrode active material, and a cover layer containing a cover material, the sulfide solid electrolyte material includes a sulfide layer containing a sulfide material and an oxide layer which contains an oxide formed by oxidation of the sulfide material and which is located on a surface of the sulfide layer, and the cover layer is provided on a surface of the electrode active material.

According to the present disclosure, the charge-discharge efficiency of a battery can be improved.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a cross-sectional view showing a schematic structure of an electrode material of Embodiment 1;

FIG. 2 is a view showing a transfer rate of metal ions of the electrode material of Embodiment 1;

FIG. 3 is a view showing a transfer rate of metal ions of an electrode material of Comparative Example A;

FIG. 4 is a view showing a transfer rate of metal ions of an electrode material of Comparative Example B;

FIG. 5 is a view showing a transfer rate of metal ions of an electrode material of Comparative Example C; and

FIG. 6 is a cross-sectional view showing a schematic structure of a battery of Embodiment 2.

### DETAILED DESCRIPTION

Hereinafter, embodiments of the present disclosure will be described with reference to the drawings.

### Embodiment 1

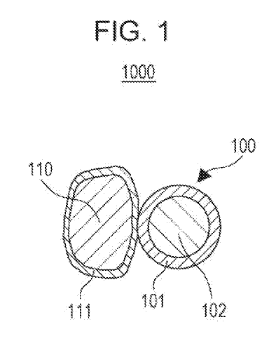

FIG. 1 is a cross-sectional view showing a schematic structure of an electrode material 1000 of Embodiment 1.

The electrode material 1000 of Embodiment 1 includes a sulfide solid electrolyte material 100, an electrode active material 110 and a cover layer 111.

The sulfide solid electrolyte material 100 includes an oxide layer 101 and a sulfide layer 102.

The sulfide layer 102 is a layer containing a sulfide material.

The oxide layer 101 is a layer containing an oxide formed by oxidation of a sulfide material. Furthermore, the oxide layer 101 is a layer located on a surface of the sulfide layer 102.

On the surface of the electrode active material 110, the cover layer 111 is provided. The cover layer 111 is a layer containing a cover material.

According to the structure described above, a charge-discharge efficiency of a battery can be improved.

In addition, in the electrode material 1000 of Embodiment 1, between the sulfide layer 102 and the electrode active material 110, metal ions (such as lithium ions) are transferred through the oxide layer 101 and the cover layer 111.

The “ionic conductivity of metal ions” (i.e., metal ion conductivity) of the oxide layer 101 is lower than the “ionic conductivity of metal ions” of the sulfide layer 102.

The “ionic conductivity of metal ions” of the cover layer 111 is lower than the “ionic conductivity of metal ions” of the oxide layer 101.

The “ionic conductivity of metal ions” of the electrode active material 110 is lower than the “ionic conductivity of metal ions” of the cover layer 111.

According to the structure described above, the charge-discharge efficiency of the battery can be improved.

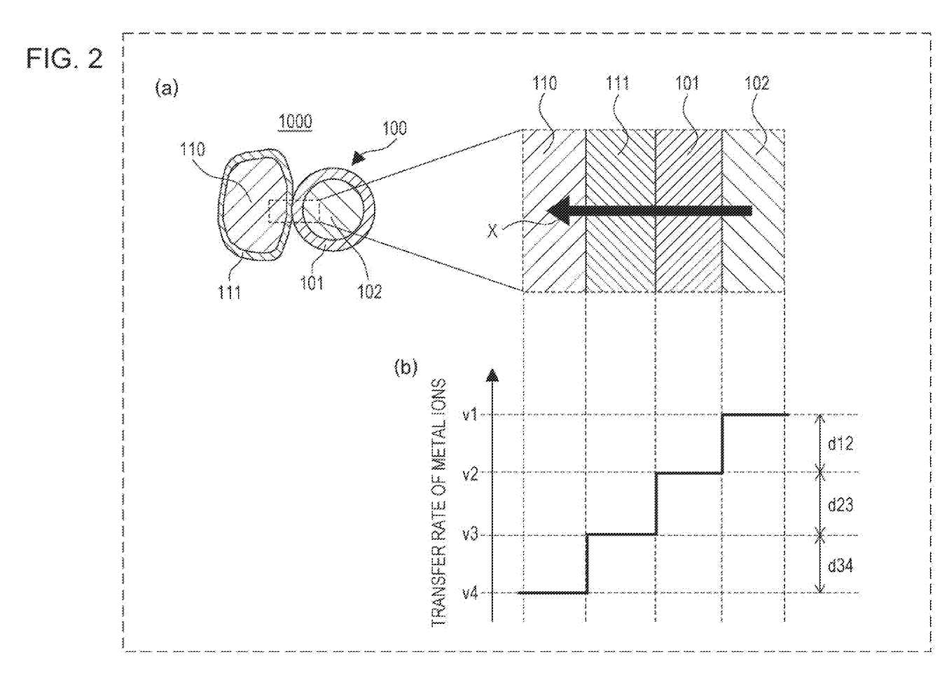

Hereinafter, with reference to FIG. 2 and Comparative Examples, the above advantage will be described in detail.

FIG. 2 is a view showing a transfer rate of metal ions of the electrode material 1000 of Embodiment 1.

FIG. 2(a) is an enlarged cross-sectional view showing interface portions among layers of the electrode material 1000 of Embodiment 1.

FIG. 2(b) is a graph showing a transfer rate of metal ions of each layer of the electrode material 1000 of Embodiment 1.

An arrow X shown in FIG. 2(a) indicates a transfer direction of metal ions. In addition, when the electrode active material 110 is a positive electrode active material, the arrow X shown in FIG. 2(a) indicates a transfer direction of metal ions when the battery is discharged.

As shown in FIG. 2(b), the transfer rates of metal ions of the layers are represented by v1 to v4. That is, v1, v2, v3, and v4 represent transfer rates of metal ions of the sulfide layer 102, the oxide layer 101, the cover layer 111, and the electrode active material 110, respectively.

In addition, d12, d23, and d34 shown in FIG. 2(b) each show the difference in transfer rate between two adjacent layers. That is, d12 indicates the difference between v1 and v2, d23 indicates the difference between v2 and v3, and d34 represents the difference between v3 and v4.

The transfer rates v1 to v4 of metal ions of the layers are each determined by the “ionic conductivity of metal ions” of the corresponding layer.

That is, since the “ionic conductivity of metal ions” of the oxide layer 101 is lower than that of the sulfide layer 102, v2<v1 holds.

In addition, since the “ionic conductivity of metal ions” of the cover layer 111 is lower than that of the oxide layer 101, v3<v2 holds.

In addition, since the “ionic conductivity of metal ions” of the electrode active material 110 is lower than that of the cover layer 111, v4<v3 holds.

Hence, in the electrode material 1000 of Embodiment 1, as shown in FIG. 2(b), v4<v3<v2<v1 holds. In other words, the transfer rates of metal ions of the sulfide layer 102, the oxide layer 101, the cover layer 111, and the electrode active material 110 are decreased in this order in a stepwise manner. Hence, d12, d23, and d34 are all not large. That is, at all the interfaces among the layers, a rapid change in transfer rate is not generated.

Accordingly, as long as the electrode material 1000 of Embodiment 1 is used, stagnation of metal ions caused by the rapid change in transfer rate can be suppressed. That is, an increase in metal ion concentration at the interface of each layer of the electrode material 1000 can be suppressed. Hence, for example, when the electrode active material 110 is a positive electrode active material, and the battery is discharged, a decrease in potential caused by the increase in metal ion concentration at the interface of each layer can be suppressed. Accordingly, an early termination of discharge caused by the decrease in potential can be prevented. As a result, the battery can be sufficiently discharged. Hence, the charge-discharge efficiency of the battery can be improved,

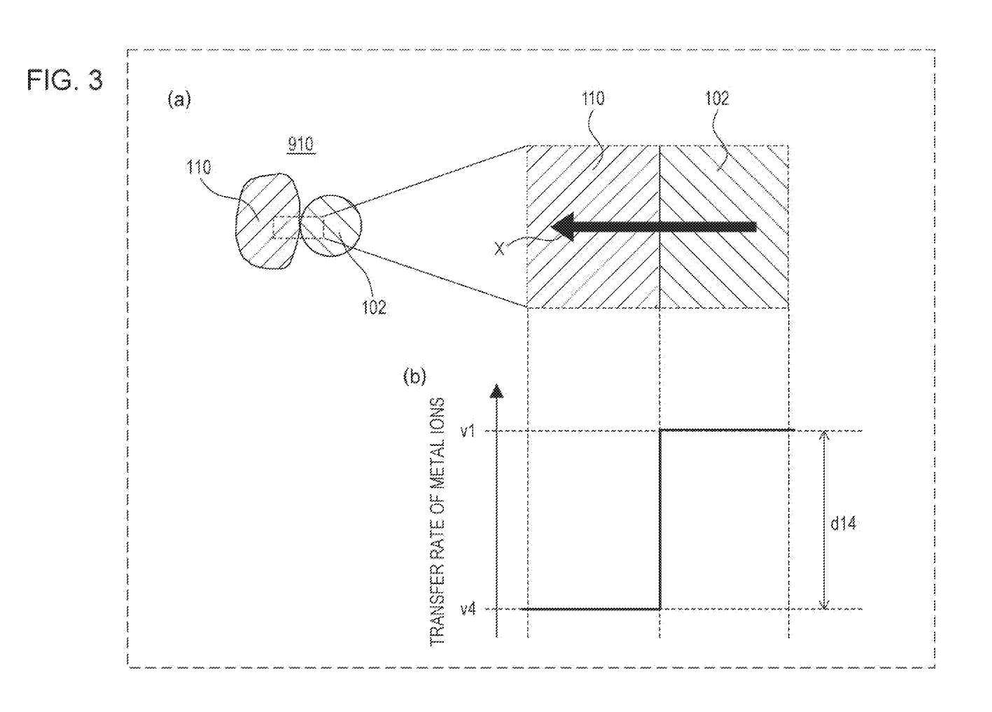

FIG. 3 is a view showing a transfer rate of metal ions of an electrode material 910 of Comparative Example A.

Hereinafter, in illustration of FIG. 3, description duplicated with that of above FIG. 2 will be appropriately omitted.

In FIG. 3(b), d14 indicates the difference between v1 and v4,

The electrode material 910 of Comparative Example A includes a sulfide solid electrolyte material formed only from the sulfide layer 102 and the electrode active material 110 without being covered with the cover layer 111.

That is, unlike the electrode material 1000 of Embodiment 1, the electrode material 910 of Comparative Example A has neither the oxide layer 101 nor the cover layer 111.

Accordingly, in the electrode material 910 of Comparative Example A, the difference d14 in transfer rate of metal ions at the interface between the sulfide layer 102 and the electrode active material 110 is increased. For example, the difference d14 is larger than any one of d12, d23, and d34 shown in FIG. 2(b). That is, at the interface between the sulfide layer 102 and the electrode active material 110, a rapid change in transfer rate is generated.

The transfer rate v4 of metal ions in the electrode active material 110 of Comparative Example A is extremely low. On the other hand, the transfer rate v1 of metal ions in the sulfide layer 102 of the sulfide solid electrolyte material of Comparative Example A is extremely high. Hence, when the electrode active material 110 is a positive electrode active material, during discharge of a battery, a diffusion rate of metal ions in the electrode active material 110 cannot follow a supply rate of metal ions from the sulfide layer 102 to the electrode active material 110. As a result, the concentration of metal ions is increased in a surface layer of the electrode active material 110, and the potential is decreased. Hence, although the metal ion concentration in the electrode active material 110 is still low (that is, although the discharge is not sufficiently performed), the discharge is terminated at an early stage. As a result, the battery cannot be sufficiently discharged. Hence, by the electrode material 910 of Comparative Example A, the charge-discharge efficiency is decreased.

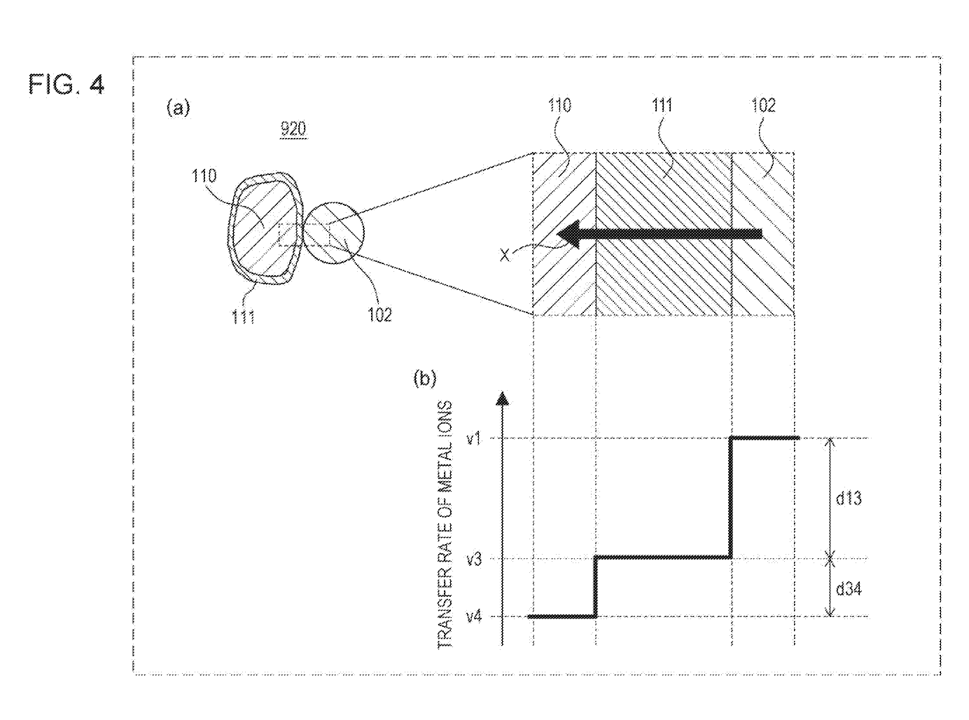

FIG. 4 is a view showing a transfer rate of metal ions of an electrode material 920 of Comparative Example B.

Hereinafter, in illustration of FIG. 4, description duplicated with that of above FIG. 2 or 3 will be appropriately omitted.

In FIG. 4(b), d13 indicates the difference between v1 and v3. In addition, d34 shown in FIG. 4(b) indicates the difference between v3 and v4.

The electrode material 920 of Comparative Example B includes a sulfide solid electrolyte material formed only from the sulfide layer 102 and the electrode active material 110 which is covered with the cover layer 111.

That is, unlike the electrode material 1000 of Embodiment 1, the electrode material 920 of Comparative Example B has no oxide layer 101.

Hence, in the electrode material 920 of Comparative Example B, the difference d13 in transfer rate of metal ions at the interface between the sulfide layer 102 and the cover layer 111 is increased. For example, the difference d13 is larger than any one of d12, d23, and d34 shown in above FIG. 2(b). That is, at the interface between the sulfide layer 102 and the cover layer 111, a rapid change in transfer rate is generated.

In Comparative Example B, a cover material forming the cover layer 111 is a lithium ion conductive oxide disclosed in International Publication No. 2007/004590. The metal ion conductivity (lithium ion conductivity) of the lithium ion conductive oxide is approximately 1×10⁻⁷ S/cm. On the other hand, the metal ion conductivity (lithium ion conductivity) of the sulfide layer 102 of Comparative Example B is approximately 1×10⁻³ S/cm.

The transfer rate v3 of metal ions of the cover layer 111 provided on the surface of the electrode active material 110 of Comparative Example B is relatively low. On the other hand, the transfer rate v1 of metal ions in the sulfide layer 102 of the sulfide solid electrolyte material of Comparative Example B is extremely high. Hence, when the electrode active material 110 is a positive electrode active material, during discharge of a battery, a diffusion rate of metal ions in the cover layer 111 and the electrode active material 110 cannot follow a supply rate of metal ions from the sulfide layer 102 to the cover layer 111. As a result, in the surface layer of the cover layer 111, the concentration of metal ions is increased, and the potential is decreased. Accordingly, although the metal ion concentration in the electrode active material 110 is still low (that is, although the discharge is not sufficiently performed), the discharge is terminated at an early stage. As a result, the battery cannot be sufficiently discharged. Hence, by the electrode material 920 of Comparative Example B, the charge-discharge efficiency is decreased.

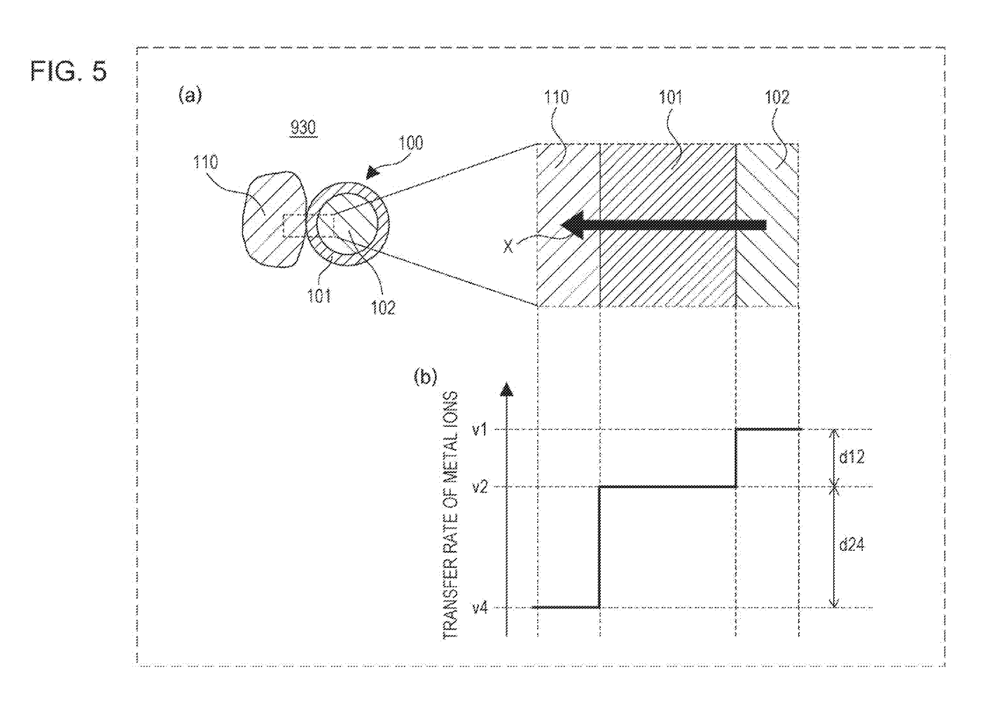

FIG. 5 is a view showing a transfer rate of metal ions of an electrode material 930 of Comparative Example C.

Hereinafter, in illustration of FIG. 5, description duplicated with that of any one of above FIGS. 2 to 4 will be appropriately omitted.

In FIG. 5(b), d12 indicates the difference between v1 and v2. In addition, d24 shown in FIG. 5(b) indicates the difference between v2 and v4,

The electrode material 930 of Comparative Example C includes the sulfide solid electrolyte material 100 having the oxide layer 101 and the sulfide layer 102 and the electrode active material 110 without being covered with the cover layer 111.

That is, unlike the electrode material 1000 of Embodiment 1, the electrode material 930 of Comparative Example C has no cover layer 111.

Hence, in the electrode material 930 of Comparative Example C, the difference d24 in transfer rate of metal ions at the interface between the oxide layer 101 and the electrode active material 110 is increased. For example, the difference d24 is larger than any one of d12, d23, and d34 shown in above FIG. 2(b). That is, at the interface between the oxide layer 101 and the electrode active material 110, a rapid change in transfer rate is generated.

In Comparative Example C, the oxide layer 101 is an oxide layer disclosed in Japanese Unexamined Patent Application Publication No. 2012-94445. The metal ion conductivity (lithium ion conductivity) of the oxide layer is approximately 1×10⁻⁵ S/cm.

The transfer rate v4 of metal ions in the electrode active material 110 of Comparative Example C is extremely low. On the other hand, the transfer rate v2 of metal ions in the oxide layer 101 of the sulfide solid electrolyte material 100 of Comparative Example C is relatively high. Hence, when the electrode active material 110 is a positive electrode active material, during discharge of a battery, a diffusion rate of metal ions in the electrode active material 110 cannot follow a supply rate of metal ions from the oxide layer 101 to the electrode active material 110. As a result, in the surface layer of the electrode active material 110, the concentration of metal ions is increased, and the potential is decreased. Accordingly, although the metal ion concentration in the electrode active material 110 is still low (that is, although the discharge is not sufficiently performed), the discharge is terminated at an early stage. As a result, the battery cannot be sufficiently discharged. Hence, by the electrode material 930 of Comparative Example C, the charge-discharge efficiency is decreased.

The low charge-discharge efficiency means that the quantity of charge stored during charge is only partially used during discharge. That is, a reversible capacity is decreased, and the energy density is decreased. As factors of decreasing the charge-discharge efficiency of a secondary battery using a related electrolyte liquid, for example, there have been known oxidation decomposition of the electrolyte during charge, degradation in current collection property caused by expansion of active materials, and film formation on a negative electrode.

The present inventor has carried out intensive research on a secondary battery using a sulfide solid electrolyte. As a result, it was found that the stagnation of metal ions caused by the difference in transfer rate of metal ions at the interface between the sulfide solid electrolyte and the positive electrode active material also functions as a factor of decreasing the charge-discharge efficiency.

Based on this point discovered by the present inventor, in the electrode material 1000 of Embodiment 1, the difference in transfer rate of metal ions between the sulfide layer 102 and the electrode active material 110 is decreased as compared to any one of those described in Comparative Examples A, B, and C. Accordingly, the charge-discharge efficiency of the battery can be improved. In particular, an initial charge-discharge efficiency of the battery can be improved. The initial charge-discharge efficiency is a ratio of an initial discharge capacity to an initial charge capacity.

In addition, in the electrode material 1000 of Embodiment 1, the metal ions may be lithium ions. In this case, the electrode material 1000 of Embodiment 1 may be used as an electrode material of a lithium secondary battery.

In addition, in the electrode material 1000 of Embodiment 1, the sulfide solid electrolyte material 100 may satisfy 1.28≦x≦4.06 and x/y≧2.60.

In this case, x indicates an oxygen/sulfur element ratio of a topmost surface of the oxide layer 101 measured by an XPS depth direction analysis.

Furthermore, y indicates an oxygen/sulfur element ratio of the oxide layer 101 at a depth of 32 nm from the topmost surface thereof based on a SiO₂ conversion sputtering rate measured by the XPS depth direction analysis.

In addition, x has a correlation with the “ionic conductivity of metal ions” (such as lithium ion conductivity) of the oxide layer 101. That is, for example, when x is small, the lithium ion conductivity is high, and when x is large, the lithium ion conductivity is low.

When 1.28≦x is satisfied, the lithium ion conductivity of the oxide layer 101 is decreased lower than 10⁻⁴ S/cm. That is, the difference in transfer rate of lithium ions between the oxide layer 101 and the cover layer 111 can be decreased. Hence, the charge-discharge efficiency can be further improved.

Furthermore, when 1.28≦x is satisfied, the oxygen/sulfur element ratio of a topmost surface of the sulfide solid electrolyte material 100 (that is, the topmost surface of the oxide layer 101) can be sufficiently increased. In other words, the ratio of oxygen bonds of the topmost surface of the sulfide solid electrolyte material 100 can be sufficiently increased. Accordingly, electrolysis of the sulfide solid electrolyte material 100 can be sufficiently suppressed at the topmost surface thereof which is to be subjected to a high potential, for example, by contact with the cover layer 111 on the electrode active material 110. Hence, the decrease of ion conductivity of the sulfide solid electrolyte material 100 caused by the electrolysis can be suppressed. As a result, degradation in charge-discharge characteristics of the battery can be suppressed.

When x≦4.06 is satisfied, the lithium ion conductivity of the oxide layer 101 is increased higher than 10⁻⁶ S/cm. That is, the difference in transfer rate of lithium ions between the oxide layer 101 and the sulfide layer 102 can be suppressed from being excessively increased. Hence, the charge-discharge efficiency can be further improved.

Furthermore, when x≦4.06 is satisfied, the oxygen/sulfur element ratio of the topmost surface of the sulfide solid electrolyte material 100 (that is, the topmost surface of the oxide layer 101) can be prevented from being excessively increased. In other words, the ratio of oxygen bonds of the topmost surface of the sulfide solid electrolyte material 100 can be prevented from being excessively increased. Accordingly, the flexibility of the topmost surface of the sulfide solid electrolyte material 100 can be prevented from being degraded by the presence of an excessive number of oxygen elements. That is, since the ratio of the oxygen bonds is appropriately decreased, a sufficient flexibility can be imparted to the topmost surface of the sulfide solid electrolyte material 100. Hence, in conformity with the shape of the electrode active material 110 or the like to be in contact with the sulfide solid electrolyte material 100, the sulfide solid electrolyte material 100 may be deformed. Accordingly, between the sulfide solid electrolyte material 100 and the cover layer 111 on the electrode active material 110 or the like, a tight contact interface at an atomic level can be formed. That is, the adhesion between the sulfide solid electrolyte material 100 and the cover layer 111 on the electrode active material 110 or the like can be improved. As a result, the charge-discharge characteristics of the battery can be further improved.

Furthermore, when x/y≧2.60 is satisfied, the oxygen/sulfur element ratio of the oxide layer 101 in the vicinity of the interface between the oxide layer 101 and the sulfide layer 102 can be sufficiently decreased. In addition, x/y has a correlation with the thickness of the oxide layer 101, and when x/y is increased, the thickness of the oxide layer 101 is decreased. When x/y≧2.60 is satisfied, the thickness of the oxide layer 101, which has a low ion conductivity, is not excessively increased, and hence, degradation in battery characteristics can be suppressed.

Furthermore, since x/y≧2.60 is satisfied, the number of oxygen bonds of the oxide layer 101 in the vicinity of the interface between the oxide layer 101 and the sulfide layer 102 can be decreased. Hence, a high ion conductivity can be maintained. As a result, the charge-discharge characteristics of the battery can be further improved/

Furthermore, since x/y≧2.60 is satisfied, the oxygen/sulfur element ratio of the oxide layer 101 in the vicinity of the interface described above can be made close to the oxygen/sulfur element ratio of the sulfide layer 102. Accordingly, at this interface, the oxygen/sulfur element ratio can be continuously changed. As a result, the bonding force between the oxide layer 101 and the sulfide layer 102 can be increased. Hence, an interface having a high adhesion can be formed between the oxide layer 101 and the sulfide layer 102. As a result, the charge-discharge characteristics of the battery can be further improved.

In addition, in the electrode material 1000 of Embodiment 1, the sulfide solid electrolyte material 100 may also satisfy 1.43≦x≦4.06 and x/y≧3.43.

According to the structure as described above, the charge-discharge efficiency can be further improved.

In addition, in Embodiment 1, as shown in FIG. 1, the sulfide layer 102 may have a grain shape.

In addition, in Embodiment 1, the sulfide layer 102 may be a layer formed only from a sulfide material. Alternatively, the sulfide layer 102 may be a layer containing as a primary component, a sulfide material. For example, the sulfide layer 102 may be a layer containing 50 percent by weight or more of a sulfide material with respect to the total of the sulfide layer 102.

In addition, in Embodiment 1, as the sulfide material contained in the sulfide layer 102, a high ion conductive material having a lithium ion conductivity of 10⁻⁴ S/cm or more may be used. For example, as the sulfide material, Li₂S—P₂S₅, Li₂S—SiS₂, Li₂S—B₂S₃, Li₂S—GeS₂, Li_{3.25}Ge_{0.25}P_{0.75}S₄, or Li₁₀GeP₂S₁₂ may be used. In addition, to the materials mentioned above, for example, LiX (X: F, Cl, Br, or I), Li₂O, MO_{q}, or LiₚMO_{q} (M: one of P, Si, Ge, B, Al, Ga, In, Fe, and Zn) (p, q: natural number) may also be added.

In addition, in Embodiment 1, the sulfide material may be Li₂S—P₂S₅.

According to the structure described above, Li₂S—P₂S₅ having a high electrochemical stability and a high ion conductivity may be used. Hence, the charge-discharge characteristics can be further improved.

In addition, in Embodiment 1, the oxygen/sulfur element ratio in the sulfide layer 102 may be sufficiently small and uniform.

By the structure described above, the sulfide solid electrolyte material 100 can maintain a higher ion conductivity.

In addition, in Embodiment 1, the oxide layer 101 may be a layer formed by oxidation of the sulfide material contained in the sulfide layer 102. For example, when the sulfide material contained in the sulfide layer 102 is Li₂S—P₂S₅, the oxide layer 101 has a structure formed by oxidation of Li₂S—P₂S₅. The “oxidation” in this case means that “at least one sulfur bond of the sulfide material contained in the sulfide layer 102 is substituted by at least one oxygen bond”. For example, when the sulfide layer 102 is formed from Li₂S—P₂S₅, as the sulfur bond, a PS₄³⁻ structure in which four sulfur elements are bonded to one phosphorus element is mainly contained. In this case, as an oxide contained in the oxide layer 101, there may be mentioned a structure, such as PS₃O³⁻, PS₂O₂³⁻, PSO₃³⁻, or PO₄³⁻, in which at least one sulfur bond of PS₄³⁻ is substituted by at least one oxygen bond.

In addition, in Embodiment 1, from the topmost surface of the oxide layer 101 to the vicinity of the interface between the oxide layer 101 and the sulfide layer 102, the oxygen/sulfur element ratio may be decreased in a stepwise manner.

According to the structure described above, in the oxide layer 101, a rapid change in element can be avoided. Hence, the bonding force in the oxide layer 101 can be improved. As a result, a stable and tight structure can be formed in the oxide layer 101.

In addition, the oxygen/sulfur element ratio from the surface (such as a grain surface layer) of the sulfide solid electrolyte material 100 to the inside thereof may be measured when etching using C60 cluster ions and an XPS analysis are used in combination.

In addition, the shape of the sulfide solid electrolyte material 100 of Embodiment 1 is not particularly limited, and for example, a needle shape, a spherical shape, or an oval shape may be mentioned. For example, the sulfide solid electrolyte material 100 of Embodiment 1 may have a grain shape.

For example, when the sulfide solid electrolyte material 100 of Embodiment 1 has a grain shape (such as a spherical shape), the median diameter thereof may be 0.1 to 100 μm.

When the median diameter is smaller than 0.1 μm, the ratio of the oxide layer 101 in the sulfide solid electrolyte material 100 is increased. Accordingly, the ion conductivity is decreased. In addition, when the median diameter is larger than 100 μm, the electrode active material 110 and the sulfide solid electrolyte material 100 may not form a preferable dispersion state in the electrode in some cases. Hence, the charge-discharge characteristics are degraded.

In addition, in Embodiment 1, the median diameter may also be 0.5 to 10 μm.

According to the structure described above, the ion conductivity of the sulfide solid electrolyte material 100 can be further increased. In addition, in the electrode, a more preferable dispersion state can be formed from the sulfide solid electrolyte material 100 and the electrode active material 110.

In addition, in Embodiment 1, the median diameter of the sulfide solid electrolyte material 100 may be smaller than that of the electrode active material 110.

According to the structure described above, in the electrode, a more preferable dispersion state can be formed from the sulfide solid electrolyte material 100 and the electrode active material 110.

In addition, in Embodiment 1, for example, when the sulfide solid electrolyte material 100 has a grain shape (such as a spherical shape), the thickness of the oxide layer 101 may be 1 to 300 nm.

When the thickness of the oxide layer 101 is smaller than 1 nm, a stepwise decrease in lithium-ion transfer rate cannot be sufficiently realized in the sulfide layer 102, the oxide layer 101, and the cover layer 111 in this order, and the charge-discharge efficiency is decreased.

In addition, when the thickness of the oxide layer 101 is larger than 300 nm, the ratio of the oxide layer 101 in the sulfide solid electrolyte material 100 is increased. Accordingly, the ion conductivity is seriously decreased.

The thickness of the oxide layer 101 may also be 5 to 50 nm.

When the thickness of the oxide layer 101 is 5 nm or more, a stepwise decrease in lithium-ion transfer rate is more preferably realized in the sulfide layer 102, the oxide layer 101, and the cover layer 111 in this order, and the charge-discharge efficiency can be further improved.

In addition, when the thickness of the oxide layer 101 is 50 nm or less, the ratio of the oxide layer 101 in the sulfide solid electrolyte material 100 is decreased. Hence, the ion conductivity can be further increased.

In the case described above, when the oxygen/sulfur element ratio of the topmost surface of the sulfide solid electrolyte material 100 measured by an XPS depth direction analysis is represented by “x”, and when the oxygen/sulfur element ratio of the sulfide layer 102 is represented by “z”, the “thickness of the oxide layer 101” is defined by a “depth at which the oxygen/sulfur element ratio is (x−z)/4 (based on SiO₂ conversion sputtering rate)”.

In addition, in Embodiment 1, the electrode active material 110 may be a material which is to be used as a generally known positive electrode active material or negative electrode active material.

The electrode active material 110 includes a material having characteristics of occluding and releasing metal ions (such as lithium ions).

As a positive electrode active material to be used as the electrode active material 110, for example, there may be mentioned a lithium-containing transition metal oxide (such as Li(NiCoAl)O₂ or LiCoO₂), a transition metal fluoride, a polyanion, a fluorinated polyanion material, a transition metal sulfide, a transition metal oxyfluoride, a transition metal oxysulfide, or a transition metal oxynitride. In particular, as the positive electrode active material, when a lithium-containing transition metal oxide is used, a manufacturing cost can be decreased, and an average discharge voltage can be increased.

In addition, in Embodiment 1, the electrode active material 110 may be Li(NiCoAl)O₂.

According to the structure described above, the energy density of the battery can be further increased.

The median diameter of the electrode active material 110 may be 0.1 to 100 μm.

When the median diameter of the electrode active material 110 is smaller than 0.1 μm, in the electrode, a preferable dispersion state may not be formed from the electrode active material 110 and the sulfide solid electrolyte material 100 in some cases. As a result, the charge-discharge characteristics of the battery are degraded.

In addition, when the median diameter of the electrode active material 110 is larger than 100 μm, lithium diffusion in the electrode active material 110 is slowed. Hence, the battery may be difficult to operate at a high output in some cases.

The median diameter of the electrode active material 110 may be larger than that of the sulfide solid electrolyte material 100. Accordingly, the electrode active material 110 and the sulfide solid electrolyte material 100 may form a preferable dispersion state.

In addition, in Embodiment 1, the cover layer 111 may be a layer formed only from a cover material. Alternatively, the cover layer 111 may be a layer containing as a primary component, a cover material. For example, the cover layer 111 may be a layer containing 50 percent by weight or more of a cover material with respect to the total of the cover layer 111.

In addition, in Embodiment 1, the cover material may be a material having a lithium ion conductivity of 10⁻⁹ to 10⁻⁶ S/cm.

Since the lithium ion conductivity of the cover material is 10⁻⁹ S/cm or more, the difference in transfer rate of lithium ions between the cover layer 111 and the oxide layer 101 can be suppressed from being excessively increased. Hence, the charge-discharge efficiency can be further improved.

In addition, since the lithium ion conductivity of the cover material is 10⁻⁶ S/cm or less, the difference in transfer rate of lithium ions between the cover layer 111 and the electrode active material 110 can be suppressed from being excessively increased. Hence, the charge-discharge efficiency can be further improved.

As the cover material, for example, there may be used a sulfide solid electrolyte, an oxide solid electrolyte, a halogenated solid electrolyte, a high molecular weight solid electrolyte, or a complex hydrogenated solid electrolyte.

In addition, in Embodiment 1, the cover material may be an oxide solid electrolyte.

The oxide solid electrolyte has an excellent high potential stability. Hence, by the use of the oxide solid electrolyte, the charge-discharge efficiency can be further improved.

As the oxide solid electrolyte to be used as the cover material, for example, there may be used a Li—Nb—O compound, such as LiNbO₃; a Li—B—O-compound, such as LiBO₂ or Li₃BO₃; a Li—Al—O compound, such as LiAlO₂; a Li—Si—O compound, such as Li₄SiO₄; a Li—Ti—O compound, such as Li₂SO₄ or Li₄Ti₅O₁₂; a Li—Zr—O compound, such as Li₂ZrO₃; a Li—Mo—O compound, such as Li₂MoO₃; a Li—V—O compound, such as LiV₂O₅; or a Li—W—O compound, such as Li₂WO₄.

In addition, in Embodiment 1, the cover material may be LiNbO₃.

LiNbO₃ has a lithium ion conductivity of approximately 10⁻⁷ S/cm, and the lithium-ion transfer rate thereof is between that of the electrode active material 110 and that of the oxide layer 101 of the sulfide solid electrolyte material 100. Furthermore, LiNbO₃ has a high electrochemical stability. Hence, by the use of LiNbO₃, the charge-discharge efficiency can be further improved.

In addition, the thickness of the cover layer 111 may be 1 to 100 nm.

When the thickness of the cover layer 111 is 1 nm or more, a stepwise decrease in lithium-ion transfer rate is more preferably realized in the electrode active material 110, the cover layer 111, and the oxide layer 101 in this order. Hence, the charge-discharge efficiency can be further improved.

In addition, when the thickness of the cover layer 111 is 100 nm or less, the thickness of the cover layer 111 having a low ion conductivity is not excessively increased. Hence, the inside resistance of the battery can be sufficiently decreased. As a result, the energy density can be increased.

In addition, the cover layer 111 may uniformly cover a grain of the electrode active material 110. Accordingly, a stepwise decrease in lithium-ion transfer rate is more preferably realized in the electrode active material 110, the cover layer 111, and the oxide layer 101 in this order.

Alternatively, the cover layer 111 may partially cover the grain of the electrode active material 110. Accordingly, the electron conductivity between a plurality of grains of the electrode active material 110 covered with the cover layer 111 is improved. Hence, the battery can be operated at a high output.

In addition, the ratio in lithium ion conductivity of the cover layer 111 to the oxide layer 101 may be smaller than 1×10⁻³. Accordingly, the difference in transfer rate of lithium ions can be further decreased. Hence, the charge-discharge efficiency can be further improved.

In addition, in the electrode material 1000 of Embodiment 1, the grain of the sulfide solid electrolyte material 100 and the grain of the electrode active material 110 may be in contact with each other as shown in FIG. 1. In this case, the cover layer 111 and the oxide layer 101 are in contact with each other.

In addition, the electrode material 1000 of Embodiment 1 may contain a plurality of grains of the sulfide solid electrolyte material 100 and a plurality of grains of the electrode active material 110.

In addition, in the electrode material 1000 of Embodiment 1, the content of the sulfide solid electrolyte material 100 may be the same as or different from the content of the electrode active material 110.

### <Method for Manufacturing Electrode Material>

The electrode material 1000 of Embodiment 1 may be manufactured, for example, by the following method.

First, the sulfide solid electrolyte material 100 may be manufactured, for example, by the following method.

Before the oxide layer 101 is provided, a material forming the sulfide layer 102 is used as a precursor. The precursor is placed in an electric furnace in which the oxygen partial pressure is arbitrarily controlled. Subsequently, a heat treatment is performed at an arbitrary temperature for an arbitrary time, so that an oxidation treatment is performed. Accordingly, the sulfide solid electrolyte material 100 having a grain surface layer formed of the oxide layer 101 is obtained.

In addition, for the control of the oxygen partial pressure, an oxygen gas may be used. Alternatively, an oxidant releasing oxygen at a predetermined temperature may be used as an oxygen source. For example, by adjustment of the addition amount of an oxidant (such as KMnO₄), the position at which an oxidant is placed, the filling condition of an oxidant, and the like, the degree (that i oxygen/sulfur element ratio of the oxide layer 101) of the oxidation treatment can be adjusted.

In addition, the electrode active material 110 covered with the cover layer 111 may be manufactured, for example, by the following method.

A cover solution in which a raw material of the cover material is dissolved in a solvent is formed. Next, a raw material of the positive electrode active material is mixed with the cover solution (in addition, a step, such as a heat treatment, may also be added). Accordingly, the electrode active material 110 covered with the cover layer 111 is obtained.

The sulfide solid electrolyte material 100 and the electrode active material 110 thus obtained are mixed together at a predetermined mixing ratio. As a result, the electrode material 1000 can be obtained.

### Embodiment 2

Hereinafter, Embodiment 2 will be described. Description duplicated with that of above Embodiment 1 will be appropriately omitted.

A battery of Embodiment 2 is formed using the electrode material 1000 described in above Embodiment 1.

The battery of Embodiment 2 uses the electrode material 1000 described in above Embodiment 1 and comprises a positive electrode, a negative electrode, and an electrolyte layer.

The electrolyte layer is provided between the positive electrode and the negative electrode.

One of the positive electrode and the negative electrode includes the electrode material 1000.

According to the structure described above, the stagnation of metal ions caused by a rapid change in transfer rate can be suppressed in the positive electrode or the negative electrode. That is, the increase in metal ion concentration at the interfaces among the layers of the electrode material 1000 can be suppressed. Hence, the charge-discharge efficiency of the battery can be improved.

In addition, in Embodiment 2, the electrode active material of the electrode material 1000 may be a positive electrode active material.

In this case, the positive electrode of the battery of Embodiment 2 may contain the electrode material 1000.

According to the structure described above, when the battery is discharged, the decrease in potential caused by an increase in metal ion concentration at the interfaces among the layers of the electrode material 1000 can be sufficiently suppressed. Hence, early termination of discharge caused by the decrease in potential can be prevented. As a result, the battery can be sufficiently discharged. Accordingly, the charge-discharge efficiency of the battery can be improved.

In addition, in Embodiment 2, the metal ions may be lithium ions. In this case, the battery in Embodiment 2 may be formed as a lithium secondary battery.

Hereinafter, a particular example of the battery of Embodiment 2 will be described.

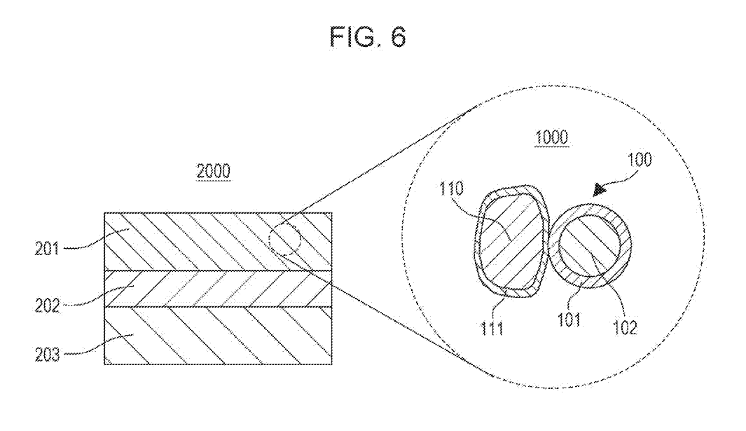

FIG. 6 is a cross-sectional view showing a schematic structure of a battery 2000 of Embodiment 2.

The battery 2000 of Embodiment 2 includes a positive electrode 201, an electrolyte layer 202, and a negative electrode 203.

The positive electrode 201 contains the electrode material 1000. The electrode active material 110 contained in the electrode material 1000 is a positive electrode active material.

The electrolyte layer 202 is disposed between the positive electrode 201 and the negative electrode 203.

As for the volume ratio “v:100−v” of the electrode active material 110 (positive electrode active material) to the sulfide solid electrolyte material 100, each of which is contained in the positive electrode 201, 30≦v≦95 may be satisfied. When v<30 holds, a sufficient energy density of the battery may be difficult to maintain in some cases. In addition, when v>95 holds, an operation at a high output may be difficult to perform in some cases.

The thickness of the positive electrode 201 may be 10 to 500 μm. In addition, when the thickness of the positive electrode 201 is smaller than 10 μm, a sufficient energy density of the battery may be difficult to maintain in some cases. In addition, when the thickness of the positive electrode 201 is larger than 500 μm, an operation at a high output may be difficult to perform in some cases.

The electrolyte layer 202 is a layer containing an electrolyte material. The electrolyte material is for example, a solid electrolyte material. That is, the electrolyte layer 202 may be a solid electrolyte layer.

As the electrolyte layer 202, for example, a sulfide material may be used. As the sulfide material, Li₂S—P₂S₅, Li₂S—SiS₂, Li₂S—B₂S₃, Li₂S—GeS₂, Li_{3.25}Ge_{0.25}P_{0.75}S₄, or Li₁₀GeP₂S₁₂ may be mentioned. In addition, to the materials mentioned above, LiX (X: F, Cl, Br, or I), Li₂O, MO_{q}, or LiₚMO_{q} (M: one of P, Si, Ge, B, Al, Ga, In, Fe, and Zn) (p, q: natural number) may be added.

The electrolyte layer 202 may contain the sulfide solid electrolyte material 100. In addition, a sulfide material which may be mentioned as the electrolyte layer 202 by way of example may also be simultaneously contained. In this case, those two materials may be uniformly dispersed with each other. Alternatively, at least one layer formed from the sulfide solid electrolyte material 100 and at least one layer formed from the sulfide material may be sequentially laminated to each other in a lamination direction of the battery. For example; a positive electrode, a layer formed from the sulfide solid electrolyte material 100, a layer formed from the sulfide material, and a negative electrode may be laminated to each other in this order. Accordingly, electrolysis on the positive electrode can be suppressed, and the charge-discharge efficiency can be further improved.

The thickness of the electrolyte layer 202 may be 1 to 300 μm. When the thickness of the electrolyte layer 202 is smaller than 1 μm, the probability of short circuit between the positive electrode 201 and the negative electrode 203 may be increased in some cases. In addition, when the thickness of the electrolyte layer 202 is larger than 300 μm, an operation at a high output may be difficult to perform in some cases.

The negative electrode 203 contains a material having characteristics of occluding and releasing metal ions (such as lithium ions). The negative electrode 203 contains, for example, a negative electrode active material.

As the negative electrode active material, for example, a metal material, a carbon material, an oxide, a nitride, a tin compound, or a silicon compound may be used. The metal material may be a single metal. Alternatively, the metal material may be an alloy. As an example of the metal material, for example, a lithium metal or a lithium alloy may be mentioned. As an example of the carbon material, for example, natural graphite, coke, graphitizing carbon, carbon fibers, spherical carbon, artificial graphite, or amorphous carbon may be mentioned. In view of the capacity density, silicon (Si), tin (Sn), a silicon compound, or a tin compound is preferably used.

The negative electrode 203 may contain a sulfide material. According to the structure described above, the lithium ion conductivity in the negative electrode 203 can be increased, and an operation at a high output can be performed. As the sulfide material, a sulfide material which may be mentioned as the electrolyte layer 202 by way of example may be used.

The negative electrode 203 may contain the sulfide solid electrolyte material 100. According to the structure described above, the increase in resistance at the interface can be suppressed, and an operation at a high output can be performed.

The median diameter of negative electrode active material grains may be 0.1 to 100 μm. When the median diameter of the negative electrode active material grains is smaller than 0.1 μm, in the negative electrode, the negative electrode active material grains and the sulfide material may not form a preferable dispersion state in some cases. Accordingly, the charge-discharge characteristics of the battery are degraded. In addition, when the median diameter of the negative electrode active material grains is larger than 100 μm, lithium diffusion in the negative electrode active material grains is slowed. Hence, the battery may be difficult to operate at a high output in some cases.

The median diameter of the negative electrode active material grains may be larger than the median diameter of the sulfide material. Accordingly, a preferable dispersion state can be formed from the negative electrode active material grains and the sulfide material.

As for the volume ratio “v:100−v” of the negative electrode active material grains to the sulfide material, each of which is contained in the negative electrode 203, 30≦v≦95 may be satisfied. When v<30 holds, a sufficient energy density of the battery may be difficult to maintain in some cases. In addition, when v>95 holds, an operation at a high output may be difficult to perform in some cases,

The thickness of the negative electrode 203 may be 10 to 500 μm. When the thickness of the negative electrode is smaller than 10 μm, a sufficient energy density of the battery may be difficult to maintain in some cases. In addition, when the thickness of the negative electrode is larger than 500 μm, an operation at a high output may be difficult to perform in some cases.

In order to increase the ion conductivity, at least one of the positive electrode 201, the electrolyte layer 202, and the negative electrode 203 may contain an oxide solid electrolyte. As the oxide solid electrolyte, for example, there may be used a NASICON type solid electrolyte represented by LiTi₂(PO₄)₃ or its element substitute, a (LaLi)TiO₃-based perovskite solid electrolyte, a LISICON type solid electrolyte represented by Li₁₄ZnGe₄O₁₆, Li₄SiO₄, LiGeO₄, or its element substitute, a garnet type solid electrolyte represented by Li₇La₃Zr₂O₁₂ or its element substitute, Li₃N or its H substitute, or Li₃PO₄ or its N substitute.

In order to increase the ion conductivity, at least one of the positive electrode 201, the electrolyte layer 202, and the negative electrode 203 may contain an organic polymer solid electrolyte. As the organic polymer solid electrolyte, for example, a compound containing a high molecular weight compound and a lithium salt may be used. The high molecular weight compound may have an ethylene oxide structure. Since having an ethylene oxide structure, the high molecular weight compound may contain a large amount of a lithium salt, so that the ion conductivity can be further increased. As the lithium salt, for example, there may be used LiPF₆, LiBF₄, LiSbF₆, LiAsF₆, LiSO₃CF₃, N(SO₂CF₃)₂, LiN(SO₂C₂F₅)₂, LiN(SO₂CF₃)(SO₂C₄F₉), or LiC(SO₂CF₃)₃. As the lithium salt, one lithium salt selected from those mentioned above may be used alone. Alternatively, as the lithium salt, at least two selected from those mentioned above may be used by mixing.

In order to facilitate receiving and sending lithium ions and to improve output characteristics of the battery, at least one of the positive electrode 201, the electrolyte layer 202, and the negative electrode 203 may contain a nonaqueous electrolyte liquid, a gel electrolyte, or an ionic liquid.

The nonaqueous electrolyte liquid contains a nonaqueous solvent and a lithium salt dissolved therein. As the nonaqueous solvent, for example, there may be used a cyclic carbonate ester solvent, a chain carbonate ester solvent, a cyclic ether solvent, a chain ether solvent, a cyclic ester solvent, a chain ester solvent, or a fluorinated solvent. As an example of the cyclic carbonate ester solvent, for example, ethylene carbonate, propylene carbonate, or butylene carbonate may be mentioned. As an example of the chain carbonate ester solvent, for example, dimethyl carbonate, ethyl methyl carbonate, or diethyl carbonate may be mentioned. As an example of the cyclic ether solvent, for example, tetrahydrofuran, 1,4-dioxane, or 1,3-dioxolan may be mentioned. As an example of the chain ether solvent, for example, 1,2-dimethoxyethane or 1,2-diethoxyethane may be mentioned. As an example of the cyclic ester solvent, for example, γ-butyrolactone may be mentioned. As an example of the chain ester solvent, for example, methyl acetate may be mentioned. As an example of the fluorinated solvent, for example, fluoroethylene carbonate, methyl fluoropropionate, fluorobenzene, fluoroethyl methyl carbonate, or fluorodimethylene carbonate may be mentioned. As the nonaqueous solvent, one solvent selected from those mentioned above may be used alone. Alternatively, as the nonaqueous solvent, at least two selected from those mentioned above may be used in combination. In the nonaqueous electrolyte liquid, at least one fluorinated solvent selected from the group consisting of fluoroethylene carbonate, methyl fluoropropionate, fluorobenzene, fluoroethyl methyl carbonate, and fluorodimethylene carbonate may be contained. As the lithium salt, for example, there may be used LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), or LiC(SO₂CF₃)₃. As the lithium salt, one lithium salt selected from those mentioned above may be used alone. Alternatively, as the lithium salt, a mixture containing at least two selected from those mentioned above may be used. The concentration of the lithium salt is for example, in a range of 0.5 to 2 mol/liter.

As the gel electrolyte, a nonaqueous electrolyte liquid impregnated in a polymer material may be used. As the polymer material, for example, a polyethylene oxide, a polyacrylonitrile, a poly(vinylidene fluoride), a poly(methyl methacrylate), or a polymer having an ethylene oxide bond may be used.

As a cation forming the ionic liquid, there may be used an aliphatic chain quaternary salt, such as a tetraalkylammonium or a tetraalkylphosphonium; an aliphatic cyclic ammonium, such as a pyrrolidinium, a morpholinium, an imidazolinium, a tetrahydropyrimidinium, a piperadinium, or a piperidinium; or a nitrogen-containing aromatic cation, such as a pyridinium or an imidazolium. As an anion forming the ionic liquid, for example, there may be used PF₆⁻, SbF₆⁻, AsF₆⁻, SO₃CF₃⁻, N(SO₂CF₃)₂⁻, N(SO₂C₂F₅)₂⁻, N(SO₂CF₃)(SO₂C₄F₉)⁻, or C(SO₂CF₃)₃⁻. In addition, the ionic liquid may contain a lithium salt.

In order to improve the adhesion between grains, at least one of the positive electrode 201, the electrolyte layer 202, and the negative electrode 203 may contain a binding agent. The binding agent is used to improve a binding property of a material forming the electrode. As the binding agent, for example, there may be mentioned a poly(vinylidene fluoride), a polytetrafluoroethylene, a polyethylene, a polypropylene, an aramid resin, a polyimide, a polyimide, a poly(amide imide), a polyacrylonitrile, a poly(acrylic acid), a poly(methyl acrylate), a poly(ethyl acrylate), a poly(hexyl acrylate), a poly(methacrylic acid), a poly(methyl methacrylate), a poly(ethyl methacrylate), a poly(hexyl methacrylate), a poly(vinyl acetate), a poly(vinyl pyrrolidone), a polyether, a poly(ether sulfone), a hexafluoropolypropylene, a styrene-butadiene rubber, or a carboxymethyl cellulose. In addition, as the binding agent, there may be used a copolymer formed from at least two materials selected from tetrafluoroethylene, hexafluoroethylene, hexafluoropropylene, a perfluoroalkyl vinyl ether, vinylidene fluoride, chlorotrifluoroethylene, ethylene, propylene, pentafluoropropylene, fluoromethyl vinyl ether, acrylic acid, and hexadiene. In addition, a mixture formed from at least two material selected from those mentioned above may also be used as the binding agent.

In addition, the battery of Embodiment 2 may be formed to have various shapes, such as a coin, a cylinder, a square, a sheet, a button, a flat, and a laminate shape.

### EXAMPLES

Hereinafter, with reference to Examples and Comparative Examples, the present disclosure will be described in detail.

### Example 1

### [Formation of Sulfide Solid Electrolyte Material]

In an argon glove box in an Ar atmosphere at a dew point of −60° C. or less, Li₂S and P₂S₅ were weighed so that a molar ratio of Li₂S:P₂S₅ was 75:25. Those materials were pulverized and mixed together using a mortar. Subsequently, by the use of a planetary ball mill, a milling treatment was performed at 510 rpm for 10 hours, so that a glass-like solid electrolyte was obtained. The glass-like solid electrolyte was heat-treated in an inert atmosphere at 270° C. for 2 hours. Accordingly, Li₂S—P₂S₅ which was a glass ceramic-like solid electrolyte was obtained.

Next, 300 mg of the Li₂S—P₂S₅ thus obtained and 15.0 mg of KMnO4 functioning as an oxidant were placed in an electric furnace and then heat-treated at 350° C. for 12 hours. Accordingly, a sulfide solid electrolyte material of Example 1 having a grain surface layer formed of an oxide layer was obtained.

### [Formation of Cover Layer on Positive Electrode Active Material]

In an argon glove box, 0.06 mg of metal Li (manufactured by The Honjo Chemical Corp.) and 2.87 mg of pentaethoxy niobium (manufactured by Kojundo Chemical Laboratory Co., Ltd.) were dissolved in 0.2 mL of super dehydrated ethanol (manufactured by Wako Pure Chemical Industries, Ltd.) to form a cover solution.

On an agate mortar, while the cover solution thus formed was gradually added to 100 mg of Li(NiCoAl)O₂ (hereinafter, referred to as “NCA”) which was a positive electrode active material, stirring was performed.

After all the cover solution was added, stirring was performed on a hot plate at 30° C. until the dryness by evaporation was confirmed by visual inspection.

A powder obtained after the dryness was placed in an alumina-made crucible and was then exposed to an air atmosphere.

Subsequently, in an air atmosphere, a heat treatment was performed at 300° C. for 1 hour.

A powder obtained after the heat treatment was re-pulverized using an agate mortar, so that a positive electrode active material of Example 1 having a grain surface layer covered with a cover layer.

A material of the cover layer was LiNbO₃.

### [Formation of Positive Electrode Mixture]

In an argon glove, the sulfide solid electrolyte material of Example 1 and the positive electrode active material (NCA covered with the cover layer) were weighed at a weight ratio of 30:70. Those materials were mixed together using an agate mortar, so that a positive electrode mixture of Example 1 was formed.

### Example 2

In an argon glove box in an Ar atmosphere at a dew point of −60° C. or less, Li₂S and P₂S₅ were weighed so that a molar ratio of Li₂S:P₂S₅ was 80:20. Those materials were pulverized and mixed together using a mortar. Subsequently, by the use of a planetary ball mill, a milling treatment was performed at 510 rpm for 10 hours, so that a glass-like solid electrolyte was obtained. The glass-like solid electrolyte was heat-treated in an inert atmosphere at 270° C. for 2 hours. Accordingly, Li₂S—P₂S₅ which was a glass ceramic-like solid electrolyte was obtained.

Next, 300 mg of the Li₂S—P₂S₅ thus obtained and 21.0 mg of KMnO₄ functioning as an oxidant were placed in an electric furnace and then heat-treated at 350° C. for 12 hours. Accordingly, a sulfide solid electrolyte material of Example 2 having a grain surface layer formed of an oxide layer was obtained.

Except that the above sulfide solid electrolyte material of Example 2 was used, a method similar to that of above Example 1 was performed, so that a positive electrode mixture of Example 2 was obtained.

### Example 3

The addition amount of KMnO₄ functioning as an oxidant was set to 15.0 mg. Except for that described above, a method similar to that of above Example 2 was performed, so that a sulfide solid electrolyte material of Example 3 was obtained.

Except that the above sulfide solid electrolyte material of Example 3 was used, a method similar to that of above Example 1 was performed, so that a positive electrode mixture of Example 3 was obtained.

### Comparative Example 1

In the heat treatment of the glass ceramic-like solid electrolyte described above, KMnO₄ functioning as an oxidant was not added.

Except for that described above, a method similar to that of above Example 2 was performed, so that a sulfide solid electrolyte material of Comparative Example 1 was obtained.

In addition, without forming the cover layer on the positive electrode active material, NCA having a grain surface layer not covered with the cover layer was used as a positive electrode active material.

Except that the sulfide solid electrolyte material of Comparative Example 1 was used, and the NCA having a grain surface layer not covered with the cover layer was used as the positive electrode active material, a method similar to that of above Example 1 was performed, so that a positive electrode mixture of Comparative Example 1 was obtained.

### Comparative Example 2

In the heat treatment of the glass-like solid electrolyte described above, KMnO₄ functioning as an oxidant was not added.

Except for that described above, a method similar to that of above Example 2 was performed, so that a sulfide solid electrolyte material of Comparative Example 2 was obtained.

Except that the sulfide solid electrolyte material of Comparative Example 2 was used, a method similar to that of above Example 1 was performed, so that a positive electrode mixture of Comparative Example 2 was obtained.

### Comparative Example 3

A method similar to that of above Example 1 was performed, so that a sulfide solid electrolyte material of Comparative Example 3 was obtained.

In addition, without forming the cover layer on the positive electrode active material, NCA having a grain surface layer not covered with the cover layer was used as a positive electrode active material.

Except that the sulfide solid electrolyte material of Comparative Example 3 was used, and the NCA having a grain surface layer not covered with the cover layer was used as the positive electrode active material, a method similar to that of above Example 1 was performed, so that a positive electrode mixture of Comparative Example 3 was obtained.

### Comparative Example 4

A method similar to that of above Example 2 was performed, so that a sulfide solid electrolyte material of Comparative Example 4 was obtained.

In addition, without forming the cover layer on the positive electrode active material, NCA having a grain surface layer not covered with the cover layer was used as a positive electrode active material.

Except that the sulfide solid electrolyte material of Comparative Example 4 was used, and the NCA having a grain surface layer not covered with the cover layer was used as the positive electrode active material, a method similar to that of above Example 1 was performed, so that a positive electrode mixture of Comparative Example 4 was obtained.

### Comparative Example 5

A method similar to that of above Example 3 was performed, so that a sulfide solid electrolyte material of Comparative Example 5 was obtained,

In addition, without forming the cover layer on the positive electrode active material, NCA having a grain surface layer not covered with the cover layer was used as a positive electrode active material,

Except that the sulfide solid electrolyte material of Comparative Example 5 was used, and the NCA having a grain surface layer not covered with the cover layer was used as the positive electrode active material, a method similar to that of above Example 1 was performed, so that a positive electrode mixture of Comparative Example 5 was obtained.

### [Measurement of Oxygen/Sulfur Element Ratio]

The following measurement was performed on each of the sulfide solid electrolyte materials of above Examples 1 to 3 and Comparative Examples 1 to 5.

That is, while the sulfide solid electrolyte material thus formed was etched by C60 cluster ions, an XPS depth analysis was performed. An oxygen/sulfur element ratio “x” of the grain topmost surface before etching was measured. In addition, an oxygen/sulfur element ratio “y” at a depth of 32 nm from the grain topmost surface based on a SiO₂ conversion sputtering rate was measured. From “x” and “y” thus measured, the ratio of “x” to “y”, that is, the ratio of the oxygen/sulfur element ratio of the grain topmost surface to the oxygen/sulfur element ratio at a depth of 32 nm, was calculated.

By the procedure described above, “x”, “y”, and “x/y” of each of the sulfide solid electrolyte materials of above Examples 1 to 3 and Comparative Examples 1 to 5 were obtained. The results are shown in the following Table 1.

### [Formation of Secondary Battery]

By the use of the positive electrode mixture of each of above Examples 1 to 3 and Comparative Examples 1 to 5, the following process was performed.

First, in an insulating outer cylinder, 80 mg of Li₂S—P₂S₅ and 10 mg of the positive electrode mixture were sequentially laminated. The laminate thus formed was pressure-molded at a pressure of 360 MPa, so that a positive electrode and a solid electrolyte layer were obtained.

Next, on the solid electrolyte layer at a side opposite to that thereof in contact with the positive electrode, metal In (thickness: 200 μm) was laminated. Subsequently, pressure molding was performed at a pressure of 80 MPa, so that a laminate formed of the positive electrode, the solid electrolyte layer, and a negative electrode was formed.

Next, stainless steel collectors were disposed on the top and the bottom of the laminate described above, and collector leads were fitted to the collectors.

Finally, by the use of insulating ferrules, the inside of the insulating outer cylinder was shield and air-tightened from the outside, so that a battery was formed.

Accordingly, the battery of each of Examples 1 to 3 and Comparative Examples 1 to 5 was formed.

### [Charge-Discharge Test]

By the use of the battery of each of Examples 1 to 3 and Comparative Examples 1 to 5, a charge-discharge test was performed under the following conditions.

The battery was disposed in a constant-temperature bath at 25° C.

A constant-current charge was performed at a current of 70 μA which corresponded to 0.05C rate (20 hour rate) relative to the theoretical capacity of the battery and was terminated at a voltage of 3.7 V.

Next, as was the case described above, discharge was performed at a current of 70 μA which corresponded to 0.05C rate and was terminated at a voltage of 1.9 V.

Accordingly, an initial charge-discharge efficiency (=initial discharge capacity/initial charge capacity) of the battery of each of Examples 1 to 3 and Comparative Examples 1 to 5 was obtained. The results are shown in the following Table.

TABLE

| | Presence of | | | | |
|---|---|---|---|---|---|
| | Cover Layer | O/S Ratio | | | Initial |
| | on Positive | x of | O/S Ratio | | Charge- |
| | Electrode | Grain | y at | | Discharge |
| | Active | Topmost | Depth of | | Efficiency |
| | Material | Surface | 32 nm | x/y | % |
| Example 1 | Yes | 1.43 | 0.42 | 3.43 | 76.73 |
| Example 2 | Yes | 4.06 | 0.98 | 4.12 | 77.57 |
| Example 3 | Yes | 2.91 | 0.68 | 4.31 | 77.84 |
| Comparative | No | 0.41 | 0.28 | 1.49 | 65.17 |
| Example 1 | | | | | |
| Comparative | Yes | 0.41 | 0.28 | 1.49 | 72.44 |
| Example 2 | | | | | |
| Comparative | No | 1.43 | 0.42 | 3.43 | 75.52 |
| Example 3 | | | | | |
| Comparative | No | 4.06 | 0.98 | 4.12 | 74.41 |
| Example 4 | | | | | |
| Comparative | No | 2.91 | 0.68 | 4.31 | 74.83 |
| Example 5 | | | | | |

### <Discussion>

From the results described above, the following effects were confirmed.

From the result of Comparative Example 1, it was confirmed that when the positive electrode active material was not covered with the cover layer, and when the sulfide solid electrolyte material had no oxide layer which satisfied 1.28≦x≦4.06 and x/y≧2.60, the charge-discharge efficiency was low.

From the result of Comparative Example 2, it was confirmed that since the positive electrode active material was covered with the cover layer, the charge-discharge efficiency was improved as compared to that of Comparative Example 1. However, in Comparative Example 2, it was confirmed that the degree of improvement in charge-discharge efficiency was not sufficient as compared to that of each of Examples 1 to 3.

From the results of Comparative Examples 3 to 5, it was confirmed that since the sulfide solid electrolyte material had the oxide layer which satisfied 1.28≦x≦4.06 and x/y≧2.60, the charge-discharge efficiency was improved as compared to that of Comparative Example 1, However, it was confirmed that in Comparative Examples 3 to 5, the degree of improvement in charge-discharge efficiency was not sufficient as compared to that of each of Examples 1 to 3.

From the results of Examples 1 to 3, it was confirmed that since the positive electrode active material was covered with the cover layer, and the sulfide solid electrolyte material had the oxide layer which satisfied 1.28≦x≦4.06 and x/y≧2.60, the charge-discharge efficiency was further improved as compared to that of each of Comparative Examples 1 to 5.

The battery of the present disclosure can be used, for example, as an all-solid lithium secondary battery.

What is claimed is:

1. An electrode material comprising:
a sulfide solid electrolyte material;
an electrode active material; and
a cover layer containing a cover material,
wherein the sulfide solid electrolyte material includes:
a sulfide layer containing a sulfide material; and
an oxide layer which contains an oxide formed by oxidation of the sulfide material and which is located on a surface of the sulfide layer, and
the cover layer is provided on a surface of the electrode active material.

2. The electrode material according to claim 1,
wherein metal ions are transferred between the sulfide layer and the electrode active material through the oxide layer and the cover layer,
the ionic conductivity of the metal ions of the oxide layer is lower than the ionic conductivity of the metal ions of the sulfide layer,
the ionic conductivity of the metal ions of the cover layer is lower than the ionic conductivity of the metal ions of the oxide layer, and
the ionic conductivity of the metal ions of the electrode active material is lower than the ionic conductivity of the metal ions of the cover layer.

3. The electrode material according to claim 1,
wherein 1.28≦x≦4.06 and x/y≧2.60 are satisfied,
where x is an oxygen/sulfur element ratio of a topmost surface of the oxide layer measured by an XPS depth direction analysis, and
y is an oxygen/sulfur element ratio at a depth of 32 nm from the topmost surface of the oxide layer based on a SiO₂ conversion sputtering rate measured by the XPS depth direction analysis.

4. The electrode material according to claim 1,
wherein the sulfide material includes Li₂S—P₂S₅.

5. The electrode material according to claim 1,
wherein the cover material includes an oxide solid electrolyte.

6. The electrode material according to claim 5,
wherein the cover material includes LiNbO₃.

7. The electrode material according to claim 1,
wherein the electrode active material includes Li(NiCoAl)O₂.

8. A battery comprising:
a positive electrode;
a negative electrode; and
an electrolyte layer provided between the positive electrode and the negative electrode,
wherein one of the positive electrode and the negative electrode contains the electrode material according to claim 1.

9. The battery according to claim 8,
wherein the electrode active material is a positive electrode active material, and
the positive electrode contains the electrode material.
